(19) United States
(12) Patent Application Publication
(10) Pub. No.: US 2024/0210107 A1
(43) Pub. Date: Jun. 27, 2024

(54) DEWATERING SYSTEM WITH ULTRASOUND AND RELATED METHODS

(71) Applicant: GEORGIA TECH RESEARCH CORPORATION, Atlanta, GA (US)

(72) Inventors: M. Saad Bhamla, Atlanta, GA (US); Udita Ringania, Marietta, GA (US)

(21) Appl. No.: 18/555,796

(22) PCT Filed: Apr. 22, 2022
(86) PCT No.: PCT/US2022/025881

§ 371 Date: Oct. 17, 2023

Related U.S. Application Data
(60) Provisional application No. 63/177,979, filed on Apr. 22, 2021.

(51) Int. Cl. F26B 5/02; B07B 1/10; B07B 1/40; F26B 5/12; F26B 5/14

(52) U.S. Cl. CPC F26B 5/02; B07B 1/10; B07B 1/40; F26B 5/12; F26B 5/14; B07B 2230/01; B07B 2230/04

(57) ABSTRACT

A dewatering system includes a platform having a first side configured to receive a material thereon and an opposing second side, the platform having a plurality of pores extending between the first and second side, wherein the material comprises a solid portion and a liquid portion; and an ultrasound transducer in communication with the platform and configured to vibrate the material on the platform such that the liquid portion passes through the plurality of pores and the solid portion remains on the platform.

### FIELD OF THE INVENTION

The present invention relates to a dewatering system, and more particularly to a dewatering system using ultrasound and related methods.

### BACKGROUND

Cellulose nanomaterials have wide applications with promising properties. However, one hindrance to their wide scale industrial application has been associated with the economics of dewatering and drying and the ability to redisperse cellulose nanomaterials back into suspension without introducing agglomerates or loss of yield.

### SUMMARY OF EMBODIMENTS OF THE INVENTION

According to some embodiments of the present inventive concept, a dewatering system includes a platform having a first side configured to receive a material thereon and an opposing second side, the platform having a plurality of pores extending between the first and second side, wherein the material comprises a solid portion and a liquid portion; and an ultrasound transducer in communication with the platform and configured to vibrate the material on the platform such that the liquid portion passes through the plurality of pores and the solid portion remains on the platform.

In some embodiments, the ultrasound transducer comprises a mesh transducer having a vibrating mesh surface, and platform is provided by the vibrating mesh surface of the mesh transducer.

In some embodiments, the ultrasound transducer has a frequency of about 20 kHz to about 2 MHz.

In some embodiments, the solid portion of the material is in a slurry or suspension with the liquid portion of the material.

In some embodiments, the ultrasound transducer comprises a ring-shaped piezoelectric ultrasound transducer having the plurality of pores in a central portion.

In some embodiments, the platform and the plurality of pores are provided by a mesh on the ring-shaped piezoelectric ultrasound transducer.

In some embodiments, the plurality of pores has a graduated diameter that is larger on a first side of the platform and decreases as the pores extend to the second side of the platform.

In some embodiments, a diameter of the plurality of pores is less than 10 μm.

In some embodiments, the device includes a vacuum supply configured to apply a negative pressure to the second side of the platform.

In some embodiments, the material comprises cellulose nanofiber.

In some embodiments, a filter is on the platform, and the filter is configured to further filter the liquid portion from the solid portion.

In some embodiments, the plurality of pores is sized and configured to allow the liquid portion to pass through the plurality of pores and to maintain the solid portion of the material on the platform.

In some embodiments, a hydrophobic surface is on the platform.

In some embodiments, a dewatering system includes the dewatering device described herein and a holder configured to hold the dewatering device.

In some embodiments, the dewatering system includes a supplier configured to supply the material to the platform.

In some embodiments, the material supplier comprises a syringe.

In some embodiments, the holder is configured to hold the platform and the ultrasound transducer in a vertical configuration.

In some embodiments, the dewatering system includes a movable blade configured to move in a direction along the platform to move the material from one end of the platform to another, opposite end of the platform.

In some embodiments, the holder comprises a conveyor configured to move the material along the platform and the transducer.

In some embodiments, the dewatering system includes a plurality of dewatering devices positioned along the conveyor.

In some embodiments, the holder comprises a cylinder having a hollow middle portion and an outer surface, and the cylinder is configured to receive the material in the hollow middle portion, and the dewatering device comprises a plurality of dewatering devices on the cylinder.

In some embodiments, the plurality of dewatering devices is positioned on the cylinder such that the second side of each of the plurality of dewatering devices are on the outer surface of the cylinder.

According to some embodiments of the present inventive concept, a dewatering method comprising: providing a material on a platform, the platform having a first side configured to receive the material thereon and an opposing second side, the platform having a plurality of pores extending between the first and second side, and the material comprises a solid portion and a liquid portion; and sonicating the material with an ultrasound transducer in communication with the platform and that is configured to vibrate the material on the platform such that the liquid portion passes through the plurality of pores and the solid portion remains on the platform.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a schematic diagram of a dewatering device according to some embodiments.

FIG. 2A is a top view of an image of the dewatering device of FIG. 1.

FIG. 2B is a bottom view of the ring-shaped transducer of the dewatering device of FIG. 1

FIG. 2C is a schematic view of the ring dewatering device of FIG. 1.

FIG. 2D is a scanning electron microscope (SEM) image of the mesh pores of the platform of the device of FIG. 1

FIG. 2E is a top perspective view of a cellulose material on a top side of the dewatering device of FIG. 1

FIG. 2F is a side view of the dewatering device of FIG. 1 in operation.

FIG. 3A is a perspective schematic view of a dewatering system incorporating the dewatering device of FIG. 1 according to some embodiments.

FIG. 3B is a front schematic view of the system of FIG. 3A.

FIGS. 4A-4C are front view of holders for holding the dewatering device of FIG. 1.

FIG. 5A is a front view of a holder for holding the dewatering device of FIG. 1.

FIG. 5B is an exploded view of the holder of FIG. 5A.

FIG. 6 is a schematic view of a dewatering system using the holder of FIGS. 5A-5B.

FIG. 7 is front view of a planar holder for a dewatering system incorporating an array of dewatering devices according to some embodiments.

FIG. 8 is side schematic view of a conveyor for a dewatering system incorporating a linear array of dewatering devices according to some embodiments.

FIG. 9 is a perspective schematic view of a cylindrical holder for a dewatering system incorporating an array of dewatering devices according to some embodiments.

FIG. 10A is a graph of the percentage of water removed versus a flow rate in a syringe system as shown in FIG. 3A.

FIG. 10B is a graph of the final concentration of nanofibrillated cellulose (NFC) (Final weight percentage) at different flow rates in a syringe system as shown in FIG. 3A.

FIG. 10C is a dewatering rate of the various flow rates in a syringe system as shown in FIG. 3A.

FIGS. 11A-11B are images of redispersed suspensions of ultrasonic dewatered CNFs at various flow rates along with the diluted reference CNF sample for a two-transducer configuration in a syringe system as shown in FIG. 3A with a 1 weight percentage sample (FIG. 11A) and a 0.1 weight percentage sample (FIG. 11B).

FIGS. 12A-12B are phase contrast optical microscopic images using a 20× magnification lens for the fibrils in suspension for an original CNF sample diluted to 0.01 weight percentage sample (FIG. 12A) and for a CNF sample dewatered using a 0.01 weight percentage sample in the two-transducer configuration in a syringe system as shown in FIG. 3A (FIG. 12B).

FIGS. 13A-13F are graphs of histogram data for length and width of the redispersed samples subjected to ultrasonic dewatering at a two-transducer configuration of the system of FIG. 3A and various flow rates. At least 10 images (>600 fibrils) for each sample are analyzed. FIG. 13A is a histogram of fibril length date for 10 ml/hr. flow rate samples plotted along with the reference sample. Fibril length data for samples dewatered at 15 ml/hr (FIG. 13B), 30 ml/hr. (FIG. 13C) and 60 ml/hr. flow rates (FIG. 13D) are shown. FIG. 13E is a histogram of the fibril width for 10 ml/hr for flow rate samples plotted along with the reference sample. Fibril width data for samples dewatered at 15 ml/hr (FIG. 13F), 30 ml/hr (FIG. 13G) and 60 ml/hr (FIG. 13H) flow rates are shown.

FIG. 14A-D are contrast SEM images of original CNF diluted to 0.001 wt. % (FIGS. 14A-14B) and CNF dewatered to 11 wt. % (FIGS. 14C-14D) redispersed and diluted to 0.001 wt. %, at different resolutions. Scale bars are 10 μm.

FIGS. 15A-15B are histogram of the widths of the original fibrils (FIG. 15A) and ultrasonic dewatered fibril to 11 wt. % and redispersed to 0.001 wt. % (FIG. 15B) both showing most of the fibril width ranging between 20-500 nm. The insets show fibrils width ranging between 20 nm-4 μm, a demonstration of the nature of these fibrils.

### DETAILED DESCRIPTION OF EMBODIMENTS OF THE INVENTION

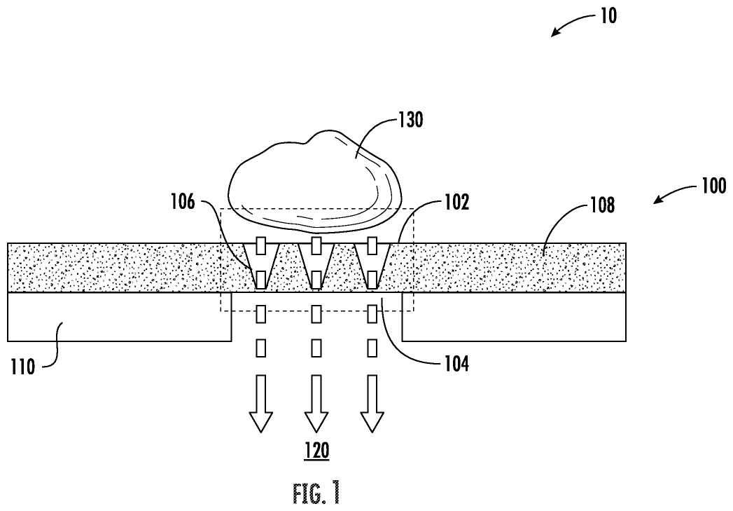

As illustrated in FIG. 1, a dewatering device 10 includes a platform 100 with a first or top side 102 and an opposite second or bottom side 104. The platform 100 includes a plurality of pores 106 that extend between the top side 102 and the bottom side 104 of the platform 100. In some embodiments, the platform 100 includes a mesh layer 108 that provides the pores 106 therein.

An ultrasound transducer 110 is in communication with the platform 100 and is configured to vibrate or communicate ultrasound energy to the platform 100. A dewatering material 130 is positioned on the top side 102, and the material 130 includes a liquid portion and a solid portion. The ultrasound transducer 110 is configured to mechanically vibrate the material 130 such that the liquid portion of the material 130 passes through the pores 106 in the form of droplets 120, and the solid portion of the material 130 remains on the top side 102 of the platform 100. The ultrasound transducer 110 may be positioned along one or more regions of the platform 100 to provide ultrasound energy and/or to vibrate the platform 100. In some embodiments, the ultrasound transducer 110 is a ring-shaped transducer; however, any suitable configuration may be used, including square or rectangular transducers or linear transducers. The transducer(s) may be positioned on the top side 102 or the bottom side 104 of the platform.

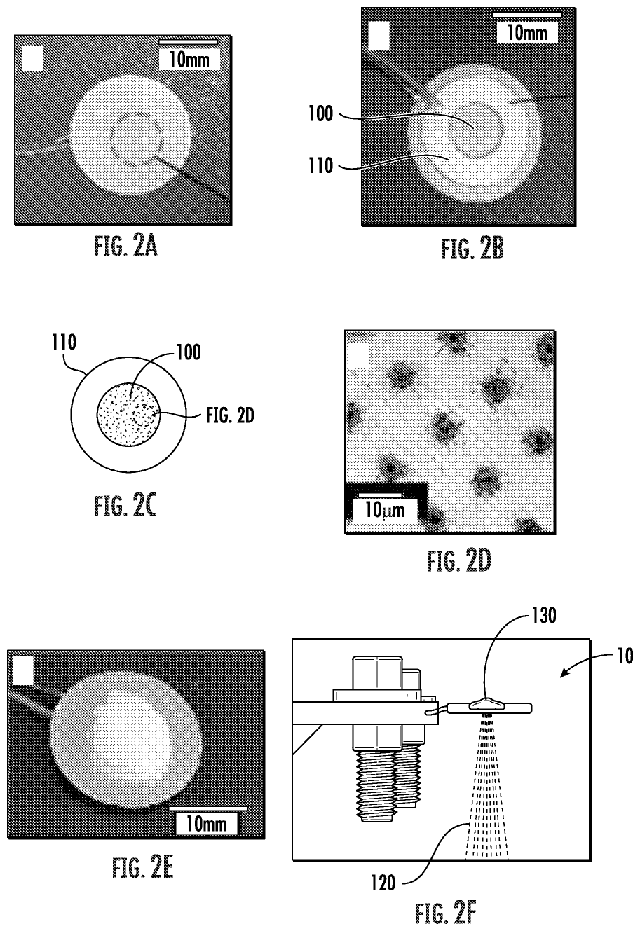

As shown in FIGS. 2A-2F, the dewatering device 10 may be a circular mesh transducer (see, e.g., FIG. 2D) with a ring-shaped ultrasound transducer 110 with the pores 106 in a central portion of the transducer 110. FIG. 2A is a top view of an image of the dewatering device 10 showing the top side 102 of the platform 100. FIG. 2B is a bottom view of the ring-shaped transducer 110. FIG. 2C is a schematic view of a ring dewatering device 10, and FIG. 2D is a scanning electron microscope (SEM) image of the mesh pores of the platform 100 of the device 10. FIG. 2E is a top perspective view of a cellulose material on a top side 102 of the dewatering device 10, and FIG. 2F is a side view of the dewatering device 10 in operation in which the material 130 is on a top side 102 of the device 10, and droplets 120 exit the pores 106 from the bottom side 104. The ultrasound transducer 110 may be a piezoelectric ultrasound transducer.

In some embodiments, the ultrasound transducer has a frequency of about 20 kHz to about 2 MHz. The solid portion of the material 130 may be in a slurry or suspension with the liquid portion of the material. The solid portion of the material 130 may be nanofibrillated cellulose (NFC). Nanofibrillated cellulose refers to cellulose fibers that are fibrillated to achieve agglomerates of cellulose microfibril units. Nanofibrillated cellulose may have fibers that are nanoscale (less than 100 nm) and have a length of several micrometers (0.5, 1, 2, 3, 4, 5 or more micrometers).

In some embodiments, the dewatering operation is carried out without further heating the material 130. Although energy from the ultrasound transducer 110 may result in some heating of the material 130, the device does not rely on a separate heating device or thermal energy to dewater the material. For example, the temperature increase of the material 130 due to the ultrasound energy from the device 10 may be less than the temperature that results in thermal degradation of the material, such as less than 10° C., less than 20° C., less than 25° C. or less than 30° C. Accordingly, the properties of the solid portion of the material 130 may be preserved during the dewatering process. For example, for a fibrous material, the length of the fibers, the diameter of the fibers, the strength and/or elasticity of the fibers are the same after the dewatering process is performed. In addition, the ultrasound dewatering described herein may utilize less energy with faster dewatering rates than previous drying methods.

In some embodiments, the pores 106 have a graduated diameter that is larger on the top side 102 of the device 10 and decreases toward the bottom side 104 of the device 10. For example, the outlet of the pores 106 on the bottom side 104 may be less than 10 μm. The inlet of the pores 106 on the top side 102 may be greater than the outlet on the bottom side 104. For example, the inlet of the pores 106 on the top side 102 may have a diameter that is increased compared to the diameter of the outlet of the pores 106 on the bottom side 104 of the device 104. That is, the inlet of the pores 106 may be increased by 10%, 20%, 30%, 50%, 70%, 100%, or 400% or more as compared to the diameter of the outlet (e.g., the inlet may have a diameter of 11 μm, 12 μm, 13 μm, 15 μm, 17 μm, 20 μm, 40 μm, or more). In some embodiments, the pore diameter may be determined based on the properties of the solid material subjected to the dewatering process. For example, the ratio of the outlet pore diameter to the length of the fibers may be less than 500.

In some embodiments, a negative pressure from a vacuum supply may be applied to the bottom side 104 of the dewatering device 10 to further facilitate removal of liquid from the material 130. An optional filter may be provided on the platform 100 to further filter the liquid portion from the solid portion.

As shown, for example, in FIG. 2F, the dewatering device 10 may be used in a dewatering system in which the dewatering device is mounted on a holder or frame and a supplier is used to supply the material to the system. Dewatering systems according to embodiments of the inventive concept may include batch mode or continuous mode systems for dewatering materials. Such dewatering systems may be used for dewatering a variety of products, including cellulose nanomaterials, protein engineering, the pharmaceutical industry, paper industry, polymer industry, food industry, and other slurry, liquid, and gel-based materials that comprise particles or fibers.

Various types of non-limiting example dewatering systems will now be described.

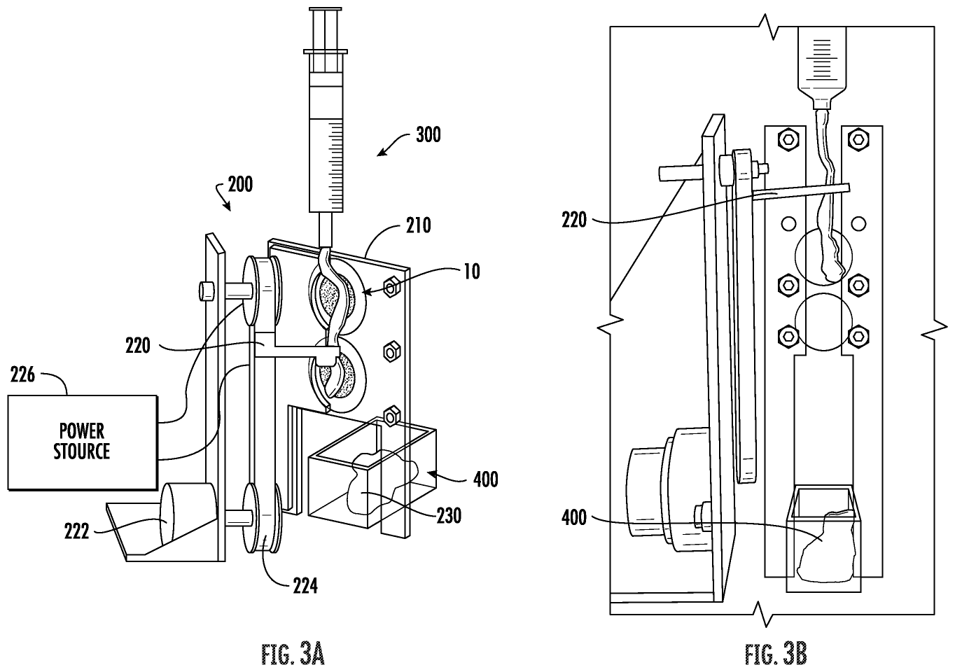

As illustrated in FIGS. 3A-3B, a dewatering system includes one or more dewatering devices 10 mounted on a holder 200. A syringe 300 is positioned above the holder 200 and the dewatering devices 10 to supply the material 230 to the dewatering devices 10. The holder 200 includes a mounting plate 210 and a moving arm or scraper blade 220 that is moved by an actuator 222 powered by a power source 226 that drives a belt 224. A collection container 400 is positioned at the bottom of the holder 200 to collect the dewatered material 230.

In this configuration, the material 230 is expelled from the syringe 300 onto the ultrasound dewatering devices 10. In some embodiments, the material 230 is hydrophilic and adheres or sticks to the vertical top side 102 of the dewatering device 10. The material 230 slides downward toward the container 400 as the material is dewatered by the ultrasound transducers of the dewatering device 10. The material 230 may move towards the container 400 due to a combination of gravity and/or the material 230 may be moved by the blade 220. The blade 220 may be a spatula or other blade-like structure that is periodically moved along the dewatering devices 10 to move the material 230 into the collection container 400.

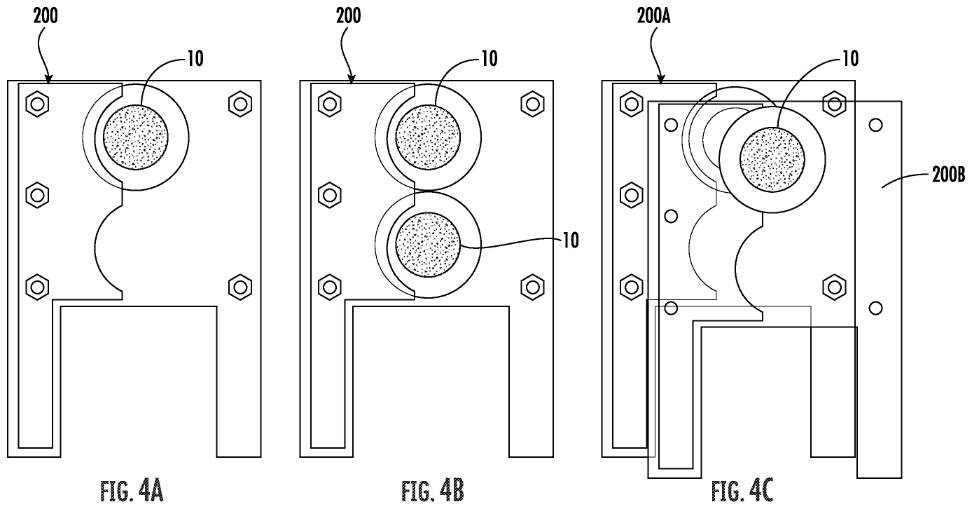

As illustrated in FIGS. 4A-4C, the holder 200 can be configured to hold one dewatering device 10 (FIG. 4A) or two (or more) dewatering devices 10 in series (FIGS. 4B). The holder 200 can include two plate portions 200A, 200B with the dewatering device 10 sandwiched between the portions 200A, 200B (FIG. 4C).

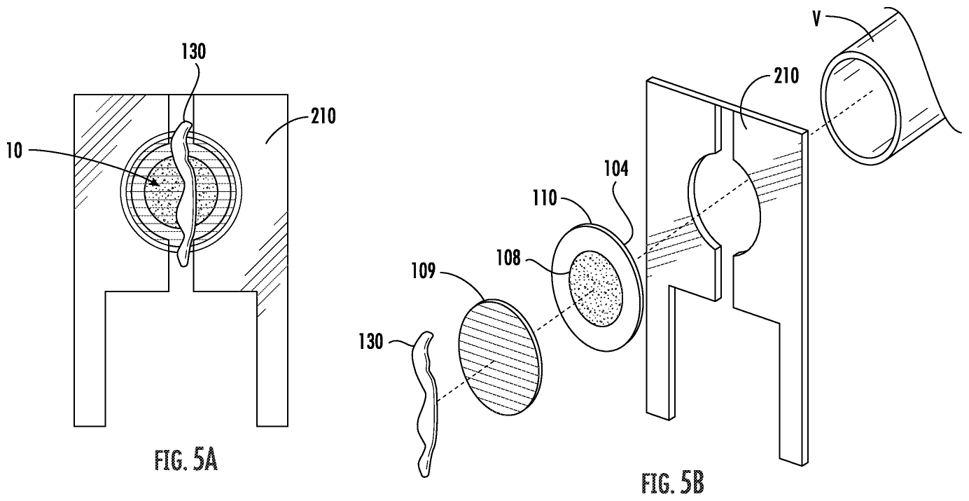

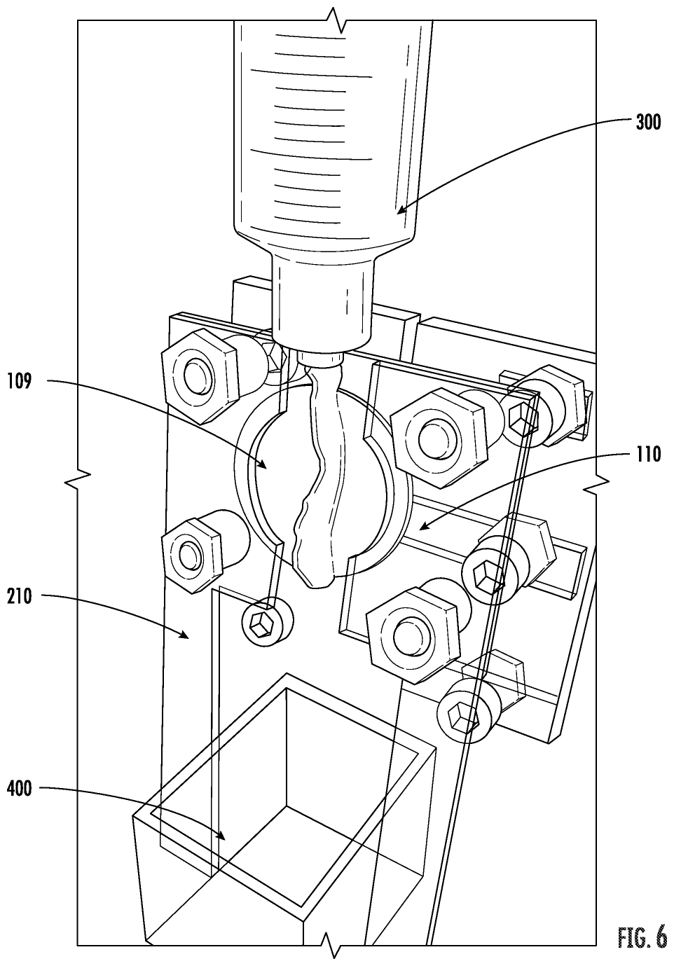

As shown in FIGS. 5A-5B and FIG. 6 the holder 200 can include a plate 210 that is configured to receive the transducer 110 with the mesh layer 108, a membrane or filter 109, with the material 130 thereon. In the configurations of FIGS. 5A-5B and FIG. 6, a vacuum source V (FIG. 5B) may be applied to the side 104 opposite the material 130 to facilitate dewatering of the material 130 when the transducer 110 is actuated and a negative pressure is applied to further remove liquid from the material 130.

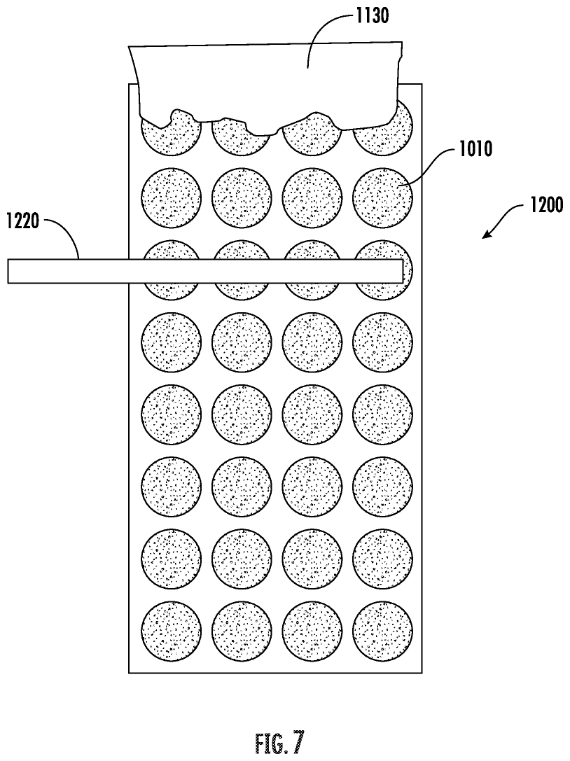

Although embodiments according to the present inventive concept are illustrated with one or two dewatering devices 10 mounted on a frame or holder 200, it should be understood that any suitable configuration may be used. For example, as illustrated in FIG. 7, an array of dewatering devices 1010 may be mounted on a holder 1200 with the material 1130 applied at a top of the holder 1200 and moving or flowing down the array of dewatering devices 1010 with the optional aid of a scraper blade 1220. The array configuration illustrated in FIG. 7 may be incorporated into dewatering systems analogous to that shown in FIGS. 5A-5B and FIG. 6 with a material supplier or syringe, a collection container, and an optional vacuum supply.

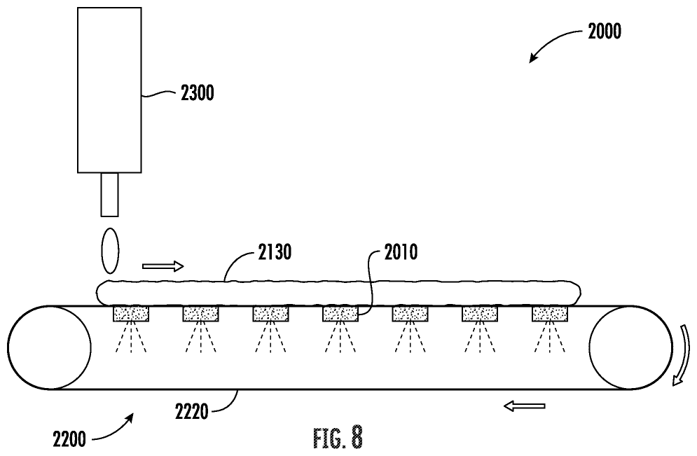

As illustrated in FIG. 8, a continuous mode dewatering system 2000 is shown. The dewatering devices 2010 are positioned along a conveyor 2200, which operates as a holder and conveys a material 2130 along on the dewatering devices 2010 such that the liquid portion is removed on the back side of the conveyor 2200. The conveyor 2200 has a conveyor belt 2220 that is driven by rollers 2210. A dewatering material supply 2300, such as a syringe, deposits the material 2130 on the conveyor 2200. The material 2010 is dewatered by the dewatering devices 2010 as it is conveyed along the conveyor belt 2220. At the end of the conveyor 2200, the material 2130 may be placed in a container (not shown).

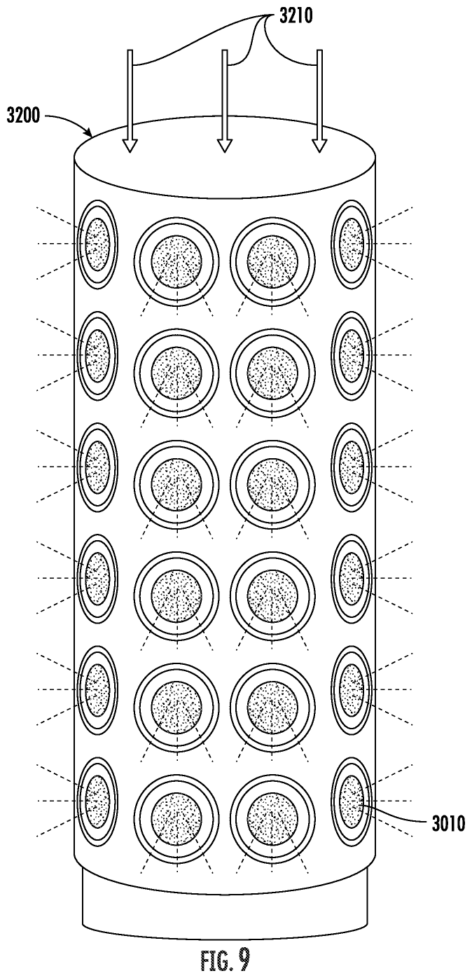

As shown in FIG. 9, another dewatering system 3000 is illustrated. The dewatering system 3000 includes a holder or cylinder 3200 with dewatering devices 3010 mounted on the cylinder 3200 such that the transducer top sides face inward and the liquid portion is expelled on an outer surface of the cylinder 3200. The dewatering material 3210 is deposited in an interior of the cylinder 3200 and the material 3210 is pushed through the cylinder 3200 by applying pressure to the material 3210. The liquid portion is removed from the outer diameter of the cylinder 3200.

Although embodiments according to the invention illustrate discrete transducer arrays for dewatering a material, it should be understood that the dewatering devices may be combined or consolidated as a single dewatering device over an area. For example, rectangular or sheet-like ultrasound transducers or transducer arrays with pores for dewatering the material may be used. In addition, although the transducer devices are illustrated by a “ring-shaped” transducer, any suitable shape may be used, including rectangular, square or linear transducers. In some embodiments, an ultrasound transducer has sufficient contact with the platform to provide ultrasound energy to the platform for dewatering. Thus, the ultrasound transducer may be on one or more sides of the platform. Moreover, the ultrasound transducers of the dewatering devices may be in contact with the dewatering material, or the ultrasound transducers may be separated by another layer or structure or by air.

Embodiments according to the present inventive concept will now be described with respect to the following non-limiting examples.

### EXAMPLES

The two modes of ultrasound application include (i) non-contact mode (or air-borne ultrasound) where the ultrasound is applied to the sample through a medium, usually air, and (ii) direct-contact mode where the ultrasound is directly applied to the sample. Air-borne ultrasound has been observed to assist the convectional air drying but suffers from significant energy attenuation due to mismatch in impedance between air and solid/liquid media. In contrast, direct-contact mode ultrasound ensures a better transfer of energy from the piezoelectric transducer to the solid/liquid in contact (Gallego-Juárez et al. 1999). For highly shrinkable food products during ultrasonic drying, applying a static pressure to the sample ensured constant contact during the entire process effectively reducing the drying time by 65-70% as compared to heated air drying (Gallego-Juárez et al. 2007). More recently, direct-contact mode has been used for dewatering knitted fabrics (Peng et al. 2017a). The low cost and easy availability of piezoelectric transducers used to produce ultrasound motivates this current work to explore the possibility for designing a low-cost direct-contact mode dewatering platform for CNFs.

In this example, ultrasound as a potential low-cost dewatering technique for CNFs suspensions is investigated. A direct contact mode approach is undertaken and the effect of system parameters such as suspension flow rate and transducer configuration on the dewatering rate and amount of water removed is studied. The viability of the ultrasonic dewatered material to be redispersed back in suspension is tested along with potential changes in CNF particle morphology. A quick effective and quantitative image analysis approach is developed for visualizing the fibrils in the solution phase using phase contrast microscopy combined with image analysis via a MATLAB code. Histograms generated thereby are compared with original fibrils to identify any changes in morphology or fibril dimensions as a result of dewatering.

### Materials and Methods

### Cellulose Nanofibers

Cellulose nanofibers (CNF) at a concentration of 3 wt. % solids in water (Lot#U-103, 90% fines retained) were procured from University of Maine, Orono, ME, USA (UMaine). These CNF were generated through mechanical fibrillation of wood pulp and are often branched or forked with dimensions about 20-500 nm in width and several microns in length. Measurements of the solid content for the CNF suspension by us confirmed a concentration of 3.1±0.4 wt. % solids.

### Vibrating Mesh Ultrasonic Transducer

Ultrasound was produced using a piezoelectric vibrating mesh transducer (VMT) (WHDTS, 20 mm diameter, rated power 1.5-2.5 W, rated voltage 70 V(max) and resonance frequency of 113 kHz ±3 kHz) which comprises of a metal mesh attached to a piezoelectric ring at the bottom as shown in FIG. 1 and FIGS. 2A-2F. The vertical vibration of the metal mesh on application of voltage across the piezoelectric ring generates an acoustic pressure difference that pushes water through the tapered pores of the metal mesh generating a cold mist ejected from the back surface of the transducer (as seen in FIGS. 1 and 2F.

### Ultrasonic Dewatering

When a CNF suspension is placed on the VMT top surface, the water from the suspension is removed as cold mist while the fibrils does not pass through the metal mesh thereby resulting in the dewatering of the suspension. This system is different from systems such as an ultrasonic spray dryer where the ultrasound is used to atomize the entire CNF suspension thereby forming microdroplets of the CNF suspension. These are then passed through a drying chamber where further thermal evaporation of the solution is carried out to achieve a dried CNF. However, water removal in the present ultrasonic dewatering method is mechanical in approach and does not employ thermal energy.

A direct-contact mode ultrasonic dewatering set-up (FIGS. 3A-3B) was designed such that CNF suspensions can flow over multiple transducers in the dewatering devices 10 allowing for continuous dewatering. In this example, the syringe 300 includes syringe pump (kd Scientific 78-0100) to control the flow rate and a 10 ml syringe (inner diameter of the outlet: 1.6 mm). The holder 200 is an acrylic transducer stand, the dewatering devices 10 are provided by vibrating mesh transducers (VMT), a function generator (RIG01 DG 1022 Function/Arbitrary Waveform Generator) and a power amplifier (Krohn-Hite Model 7602M) to drive the VMT. The scrapper blade 220 is provided by a scraper blade pully system operated via external DC motor and a collection box or container 400 to collect the dewatered CNF 230.

The dewatering that occurs as the CNF suspension flows over the transducers results in a higher viscosity CNF gel-like or paste-like material, thus a scraper blade system is incorporated to assist the gravity driven flow of the CNF material over the transducer plates. The velocity of the blade is maintained at 10% higher than the flow rate of the CNF to achieve a consistent flow over the plate. The flow rate of the CNF at the syringe outlet and the transducer configuration are varied to assess their effects on the dewatering rate and the amount of water removed. Four flow rates were studied: 60 ml/hr, 30 ml/hr, 15 ml/hr and 10 ml/hr; and two transducer configurations are used: single transducer configuration (1T) and double transducer (2T) configuration (FIGS. 4A-4B). At least 4 runs are conducted for each flow rate at each transducer configuration with the initial sample size of 5 ml each (loaded in a 10 ml syringe and initial weight (Wi) recorded using a weighing machine (METTLER TOLEDO ME0204TE/00)). The transducers are operated at 113-117 kHz and 60 Vpeak. The final dewatered samples are collected in the box at the bottom and its final weight is recorded (Wf). Temperature measurements during the continuous flow experiments indicated ˜20° C. rise in the suspension temperature over the transducer. This level of temperature rise is inconsequential for the system as it is below the thermal degradation temperature of CNF and does not drastically effect the evaporation rates.

### Characterization

### CNF Concentration Calculation

The initial concentration of the CNF in the suspension is ˜3 wt. % (Cᵢ). This is used to calculate the initial weight of the CNF solids (Fᵢ in mg) in the sample suspension of initial weight Wᵢ (in mg)

$${F}_{i} = \frac{3}{100} \times {W}_{i} \qquad 1$$

The percent of water removed from the system is calculated as follows:

$$\% water removed = \frac{{W}_{i} - {W}_{f}}{{W}_{i}} \times 100 \qquad 2$$

Here, W_{f} is the final weight of the CNF suspension collected after dewatering. The final concentration of the CNF (C_{f}) is calculated by assuming that CNF solid content in the suspension remains constant and that no CNF is lost during dewatering. Hence final CNF solids weight, F_{f}=Fᵢ

$${C}_{f} wt . \% = \frac{{F}_{f}}{{W}_{f}} \times 100 \qquad 3$$

For example, the initial CNF suspension weight of 100 mg with 3 mg of CNF solids is used. It is assumed that the final weight of the dewatered CNF suspension is 30 mg. Hence, percent water removed=((100−30)/100)*100=70%. The final CNF concentration=((3/30)*100)=10 wt. %.

### Dewatering Rate

Dewatering rate, in this study, is defined as the amount of water removed from the system in the time taken for processing 5 ml of CNF suspension at a given flow rate. It is calculated using the following equation:

$$Dewatering rate ( mg / min ) = \frac{{W}_{i} - {W}_{f}}{t} \qquad 4$$

Here, t is the time required for processing 5 ml of CNF suspension and is equal to 5 min, 10 min, 20 min and 30 min for 60 ml/hr, 30 ml/hr, 15 ml/hr and 10 ml/hr flow rates, respectively.

### Redispersion

The dewatered samples are diluted using DI water to 1 wt. %, 0.1 wt. % and 0.01 wt. % of CNF solids and redispersed via a vortex mixer (VWR Analog Vortex Mixer No. 10153-838) at speed 7 for 30 s. The original CNF sample with initial 3 wt. % is also diluted using DI water to the above weight percentages and mixed using vortex mixer to form a homogeneous suspension and act as a reference sample.

### Microscope Imaging

Phase contrast microscopy images of the fibrils for redispersed dewatered samples and diluted original CNF sample each at 0.01 wt. % are taken using an optical microscope (Nikon ECLIPSE Ti2-U). Phase contrast microscopy is a contrast enhancing optical technique that works by converting the phase shifts in light passing through a specimen into changes in brightness in the image. This technique can be directly applied to CNF suspensions thereby providing a fast and easy characterisation tool for analysing fibril distribution and dimensions. The specimens for imaging are prepared by placing a 15 μl droplet of the 0.01 wt % sample in a channel (created by placing double sided tape (thickness: 88.9 μm) ˜1.5 cm apart) on a glass slide (VWR Vista Vision™ Cat.No. 16004-430 (76.2×25.4×1)mm) and covering using a glass cover slip (Thermo Scientific™ Gold Seal™ Cover Glass (25×25) mm No1). Images are taken using the 20× objective lens and the phase 1 contrast filter. At least 3 sets of microscope samples are prepared for each dewatered sample and at least 5 images at various points of each microscope sample are taken.

### Image Analysis & Microscale Redispersion Assessment

The phase contrast microscopy images are selected for image analysis on account of their desired contrast, clarity, and fibril density. Original CNF samples (reference sample) and dewatered samples are analysed via modified version of a MATLAB code (GTFiberUND), which is uploaded in GitHub. Changes in fibril lengths and widths induced by ultrasonic dewatering relative to the original sample are assessed. The resulting length and width data are compiled into histograms.

### Contrast Scanning Electron Microscope Imaging

Contrast Scanning electron microscopy (SEM) images for redispersed dewatered fibrils and diluted original fibrils at 0.001 wt % are taken using benchtop SEM (Phenom). As CNF is a non-conductive material, these images are taken using contrast SEM imaging technique by placing the fibrils on a highly conductive substrate. The benefit of this technique it that coating of the CNF material is not needed and facilitates analysis of the nano-sized fibril structures. As SEM cannot image non-conductive materials, a high contrast image is generated between the conductive imageable substrate and the non-conductive fibril. The specimens for imaging are prepared by placing 3 droplets of 2 μl each of the 0.001 wt. % sample at 3 locations on a silicon wafer and left to air-dry overnight. At least 3 images are taken for each droplet at three different magnifications and repeated for all the samples.

### Image Analysis and Nanoscale Morphology Assessment

The SEM images are used to measure the fibril width using ImageJ to assess the nanoscale morphology of the fibrils before and after ultrasonic dewatering. Due to the lack of a better method (automated) for measuring these dense networked messy fibrils, the measurements are done manually. Every fibril is followed along its length and fibril width is measured for each branching. Measuring the same branch at multiple points is avoided as best as we could. At least 3 images for each sample are measured and the resulting width data are compiled into histograms.

### Results and Discussion

### Mechanisms of Ultrasonic Dewatering

For this study, the vibrating mesh transducer (VMT) is used to generate high frequency pressure waves. The main distinguishing feature of these transducers is the presence of a metal mesh at the center (FIGS. 1A, 2C, and 2E) supported by a piezoelectric ceramic ring at the back (FIG. 2B), which vibrates at high frequencies (resonance frequency: 113-117 kHz) on application of voltage. The metal mesh has a tapered geometry with the smaller diameter opening at the back surface (diameter: 18 μm at top surface and 3-5 μm at back surface). When a water droplet is placed on a VMT, the vibration of the metal mesh creates a pressure gradient that pushes the water through the pores resulting in the ejection of water through the back surface as a mist (FIGS. 1 and 2E). The vibrations also result in surface instabilities generated at the air-water interface of the droplet at the front surface of the transducer, resulting in droplet atomization. Thus, the VMT helps eject water as a combination of mist ejection from the mesh and droplet atomization from air-water interface.

To evaluate if water could be separated from a CNF suspension (instead of a pure water droplet), a droplet of CNF suspension (˜200 mg) is placed on the VMT and subject it to ultrasonic vibrations. The liquid from the system is ejected through the back surface of the metal mesh (FIG. 1 shows a schematic representation of the water ejected through the mesh) while a secondary liquid removal via atomization is observed from the top surface at the CNF suspension-air interface. This secondary atomization is verified using a ‘glass slide test’ as the atomization intensity is small compared to that of a pure liquid making it difficult to detect via visual inspection.

The presence of CNF in the water ejected through the mesh is tested by analyzing the solids content of the ejected water (i.e., the water was collected, allowed to dry, and the solids weighed). It is found that the fibrils ejected through the system in the water is insignificant. However, a very small quantity of CNF was seen on the back surface of the transducer mesh stuck to the plate at the end of the runs; their measured weight is insignificant (˜0.001 times the initial CNF weight in the starting suspension). Here we hypothesize that, as water is removed from the system, the fibrils come closer together creating a network that prevents the passage of CNF through the metal mesh. Thus, the ultrasonic waves act to remove the unbound excess water in the CNF suspension.

### Continuous Ultrasonic Dewatering of CNF Suspensions

Having established the feasibility of ultrasonic dewatering of CNF using VMT, an ultrasonic dewatering platform that can operate as a continuous system is provided (FIGS. 3A-3B). A continuous platform allows for faster operation times compared to a batch process and potential incorporation into an existing industrial process. The present design allows control of the CNF suspension flow rate by using a syringe pump, as well as allowing the changing the transducer configuration. The flow rate of the suspension at the syringe outlet is controlled rather than at the transducer surface which can get effected by various parameters such as gravity-effects, scraper blade velocity and changing viscosity of the suspension undergoing dewatering. Dewatering experiments focused on the effect of suspension flow rates and transducer configurations (e.g., 1T and 2T) on the extent of dewatering of CNF suspensions.

### Effect of Flow Rate

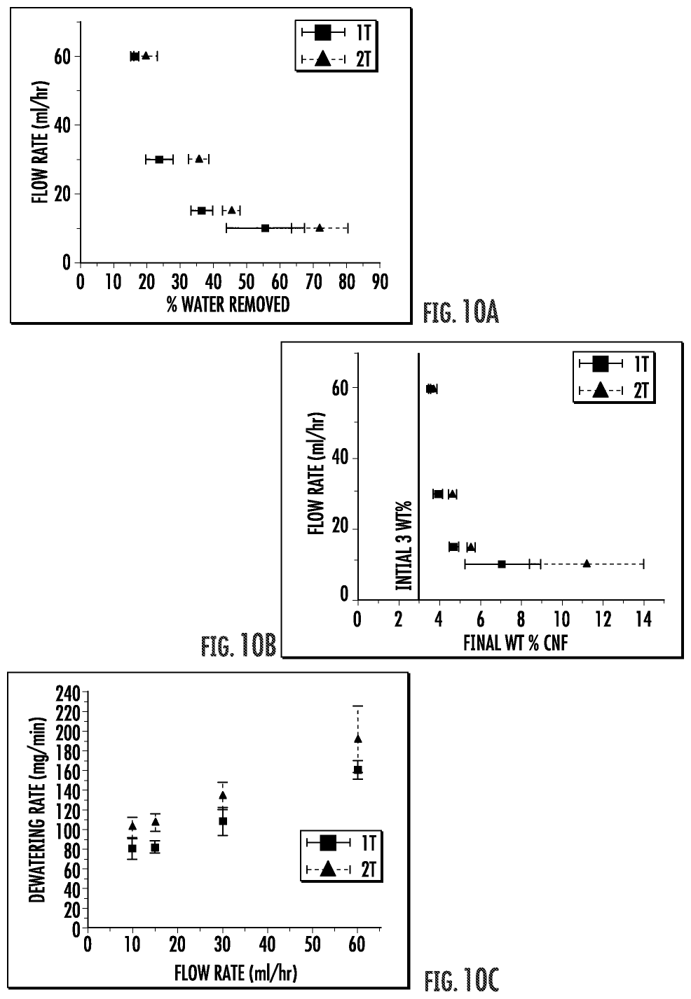

For the single transducer configuration water removal from 3 wt. % CNF suspension is 16.3±0.98 wt. %, 23.6±4 wt. %, 36.4±3.4 wt. % and 55.6±11.7 wt. % for 60 ml/hr, 30 ml/hr, 15 ml/hr and 10 ml/hr flow rates, respectively (1T, FIGS. 10A-10C). The percentage of water removal demonstrates an inverse relation with the flow rate of the CNF suspension over the transducer, increasing with lower flow rates. The highest final CNF concentration (at 1T configuration) of 7.1±1.8 wt. % is achieved at the lowest flow rate of 10 ml/hr. These results suggest that lower flow rates ensure higher contact time (residence time) between CNF suspension and the transducer surface, thereby ensuring higher exposure to the ultrasonic waves and higher extent of dewatering.

For the 2T configuration, a similar inverse trend between flow rate and percent water removal is observed, but the level of water removal is higher. Water removal for 60 ml/hr, 30 ml/hr, 15 ml/hr, and 10 ml/hr flow rates are 19.5±3.5 wt. %, 35.6±2.9 wt. %, 45.4±2.5 wt. %, and 71.9±8.3wt. %, respectively. The highest water removal of 71.9±8.3 wt. % (FIG. 10A (for 2T configuration) occurred at 10 ml/hr flow rate, and resulted in a final CNF concentration of 11.2±2.8 wt. % (FIG. 10B).

However, at lower flow rates (10 ml/hr and lower), a low-pressure induced seperation of CNF from the water is observed within the syringe. This leads to the water being pushed out of the syringe while the CNF form a campact network in the syringe making it difficult to pass through the syringe nozzle. An inhomogeneity in the initial CNF concentration exiting the syringe occurs, resulting in the higher error bars for these experimental sets (at 10 ml/hr, FIGS. 10A-10C). Such phase separation becomes severe for the 5 ml/hr flow rate experiments and hence, flow rates below 10 ml/hr are not feasible for the present setup.

### Effect of Transducer Configuration

Understanding the effect of transducer configuration on dewatering at any given flow rate can help determine the optimum operational conditions and give insight into scale-up potential of this platform. For any given flow rate, the amount of water removed and dewatering rates are higher for the 2T configuration as compared to the 1T configuration (FIGS. 10A-10C). This is attributed to the higher contact area achieved between the CNF suspension and the transducer for the 2T configuration. Interestingly the amount of water removed at the fastest flow rate of 60 ml/hr is similar for both the configurations, suggesting that there exists a critical residence time between the suspension and the transducer surface for the effects of the vibrations to significantly manifest in the system. Thus, below this critical residence time, increasing the contact area (through additional transducers) does not significantly affect the extent of dewatering for the system. Transducers can further be arranged in a sandwiched configuration, with the two transducers facing each other and CNF suspension flowing in between them. The increase in the dewatering extent with an increase in the number of transducers suggests the potential for further scale-up of the system as arrays of transducers can be leveraged to increase dewatering amount at faster flow rates.

### Dewatering Rate

Dewatering ratse for each flow rate at 1T and 2T configuration are calculated using equation 4 and presented in FIGS. 10C. Although higher extent of dewatering is achieved at lower flow rates due to prolonged contact time with the transducer surface (as seen in FIG. 10A, dewatering rates follow a reverse trend. The dewatering rate is directly proportional to the flow rate with highest dewatering rates (161±8.9 mg/min for 1T and 192±33.9 mg/min for 2T) achieved corresponding to 60 ml/hr flow rate. The dewatering rate decreases to 108±14 mg/min, 82±6 mg/min and 80.9±11 mg/ min for 1T configuration and to 134±14mg/min, 107±9 mg/min and 102±10.7 mg/min for 2T configuration at flow rates 30 ml/hr, 15 ml/hr and 10 ml/hr, respectively. This trend can be explained by the non-linear dewatering behaviour seen for VMT at static dewatering experiments. A direct dependence of the dewatering rate on the transducer number is also observed. Higher dewatering rates are observed at 2T configuration as compared to the 1T configuration for all flow rates. Thus, dewatering rate can be leveraged as a design parameter, along with the transducer configuration and flow rates, for future scale-up of the system.

### Redispersion of Dewatered CNF

Agglomeration of CNF triggered by the removal of water is a major disadvantage of dried CNFs, as the particles lose their nano-dimensions and high surface to volume ratio. As many CNF applications require a homogenously dispersed suspension of the fibrils at the nanoscale, successful redispersion of the dewatered samples to attain pre-dewatered dimensions becomes a crucial processing step. Transmission electron microscopy (TEM) and scanning electron microscopy (SEM), although widely used for assessing redispersion quality due to their nanoscale resolution, comes with inherent challenge associated with deconvoluting the effect of the drying needed in TEM and SEM sample preparation, which often lead to agglomeration triggered by droplet evaporation. Despite this they are acceptable techniques to measure the nanoscale features of CNF. In current work we use contrast SEM imaging technique to visualize and assess the fibril morphology at higher resolution to ascertain the presence of nano-dimensions.

To assess the dispersion state and the potential of agglomeration within redispersed CNF suspensions, a suspension-based characterisation technique is needed. One such technique is Dynamic Light Scattering (DLS), which has been used for calculations of hydrodynamic radius of CNMs (Foster et al. 2018). However, the fibril dimensions used in our study exceeded the size range of operation by DLS, thereby rendering this technique unapplicable in this study. Consequently, visual inspection and optical microscopy imaging of the suspension are used to evaluate the level of CNF agglomeration.

The extent of CNF agglomeration in the suspension state is assessed in two modes: macroscopically via visual inspection and microscopically via phase contrast optical microscopy. By comparing the original never dried CNF suspension (reference sample) to the redispersed dewatered CNF suspensions, it is considered here that any differences would likely be attributed to the dewatering and redispersion processes. Large agglomeration of the fibrils (>1 mm in size), identified by the presence of opaque clump like structures in the suspension, are assessed by direct visual inspection of the suspension. This provided a fast and easy initial screening for agglomeration in the redispersed system. Finer scale agglomeration of the fibrils is assessed using phase contrast microscopy imaging to inspect fibril distribution and potential agglomeration in microscale range (between 1 μm to 1000 μm). Unfortunately, assessing the fibril features and agglomeration in the nano-scale (below 1 μm) is not feasible by optical microscopy, hence, our claims are restricted to the microscale range.

### Macroscopic Redispersion

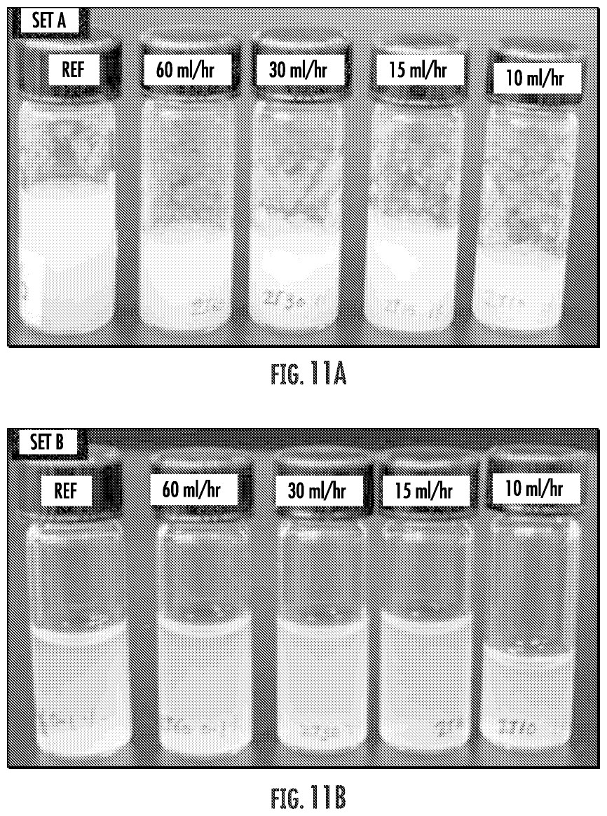

Images of the redispersed samples for various flow rates along with reference sample (original 3 wt. % CNF sample diluted to desired wt. %) at 1 wt. % and 0.1 wt. % for 2T configuration are given in FIGS. 11A-11B. Set A are samples at 1 wt. % and Set B are samples at 0.1 wt. %. Visual inspection of the redispersed samples looked very similar to the reference CNF suspension suggesting that no drastic changes in the CNF fibrils due to agglomeration occur in the redispersed state. Even the highest dewatered CNF concentration (i.e. FIGS. 11A-11B, 2T setup at 10 ml/hr flow rate, corresponding to ˜11 wt. % CNF as seen in FIGS. 10B resulted into a well redispersed suspension using the vortex mixture.

### Microscopic Redispersion

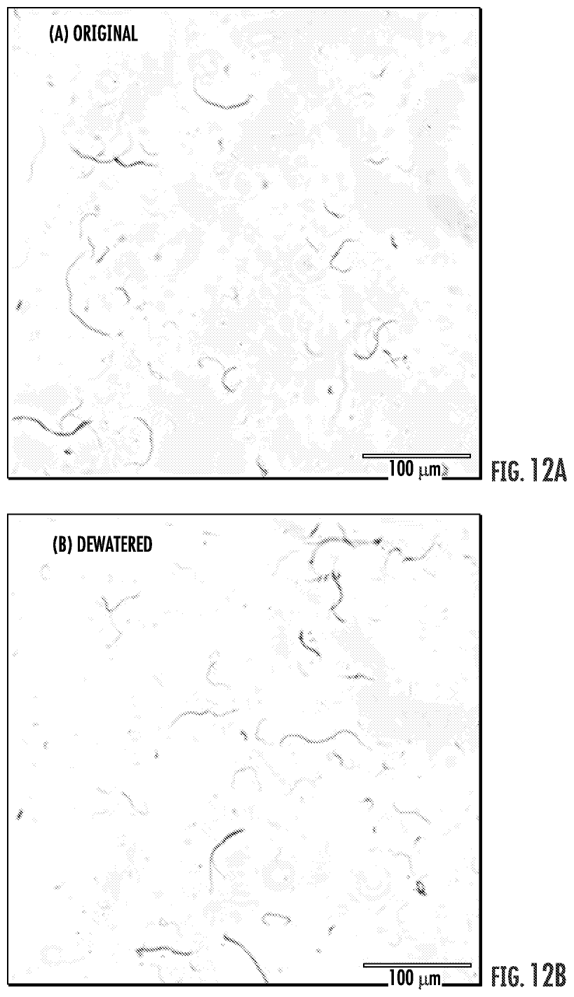

The micro-scale dispersion state and the level of CNF agglomeration is assessed by phase contrast optical microscopy. To assess if dewatering altered the level of CNF agglomeration, the redispersed suspensions were compared to the reference CNF suspensions. Images obtained for the redispersed samples using the phase contrast microscope are presented in FIGS. 12A-12B. For each sample, the images were taken at multiple different locations to rule out user bias (˜15 images per sample). A comparison with the reference sample revealed that the images for different dewatered samples are visually indistinguishable from each other. At 1 wt. % and 0.1 wt. % concentration, the fibril density was quite high forming intertwined networks. Although the fibrils looked well dispersed, at these high densities it was difficult to judge if any agglomeration is taking place. Hence, suspensions with higher dilution (i.e. 0.01 wt. %) are used to obtain sparsely packed fibril images thereby allowing us to analyse the fibril arrangement and potential agglomeration using the phase contrast mode for imaging.

Optical microscopy images at 0.01 wt. % for a diluted original CNF sample along with a redispersed dewatered sample are shown in FIGS. 12A-12B. Long branched fibrils as well as short individual fibrils are seen throughout the suspension in all the samples. The images for the ultrasonic dewatered samples are visually indistinguishable from the original sample. Hence, a more statistical approach is undertaken to assess the potential agglomeration on redispersion of the dewatered samples through analysing the changes in fibril width and length for these samples.

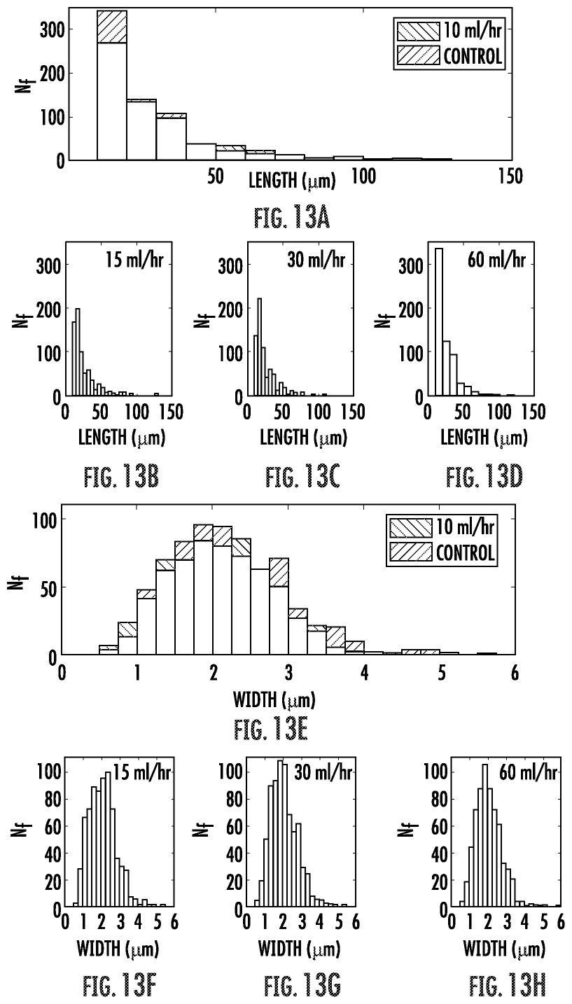

Manual calculation of the length and width of individual fibril is tedious time-consuming work and leads to user bias and manual errors. Hence a computational approach is adapted in this work where all fibrils in each image are analysed using a modified MATLAB code originally designed to analyse fibre dimensions in high contrast imaging techniques such as TEM and SEM. The phase contrast optical microscopy imaging technique used in this study successfully generated high contrast images that are compatible to be used with the code. Thus, phase contrast microscopy in combination with the MATLAB code provided a fast and easy fibril characterisation technique for CNF suspensions. At least 10 images (>600 fibrils) for each sample are analysed. The length and width data for each flow rate and the reference sample were then compiled into histogram graphs as presented in FIGS. 13A-13H. The length and width histograms have similar distributions for both the redispersed dewatered CNF suspensions and the reference CNF suspension, suggesting minimal microscopic agglomeration effects. The general trend displayed by this analysis for all the flowrates and transducer configurations (FIGS. 13A-13H) exhibits that fibril lengths and widths are widely conserved during the ultrasonic dewatering process. This dimensional conservation suggests that the ultrasonic dewatering technique presented in this study successfully removes water from CNF suspensions without inducing much if any permanent agglomeration.

### Nanoscale Fibril Morphology

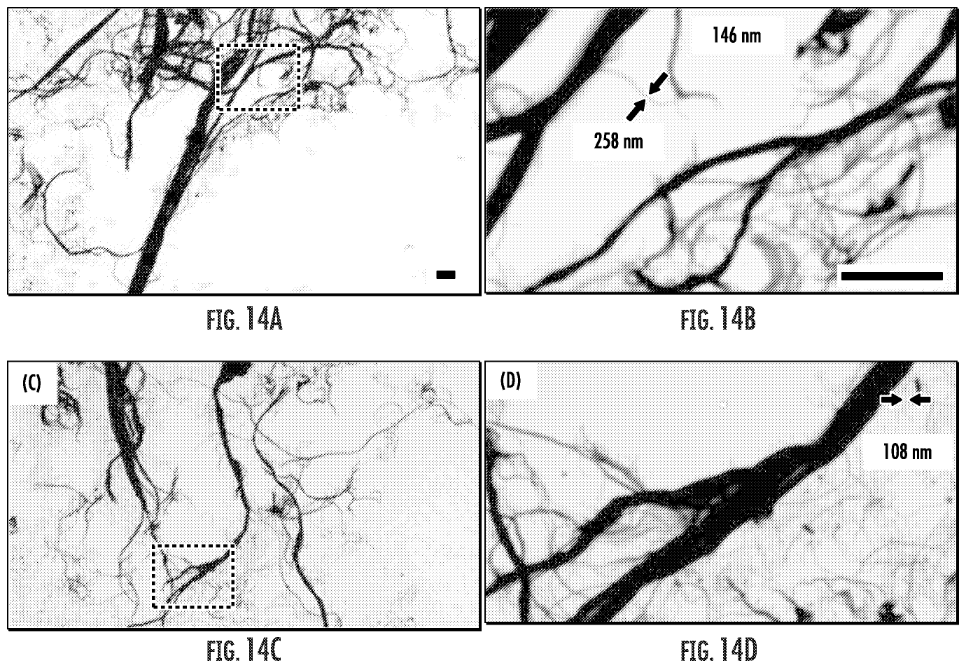

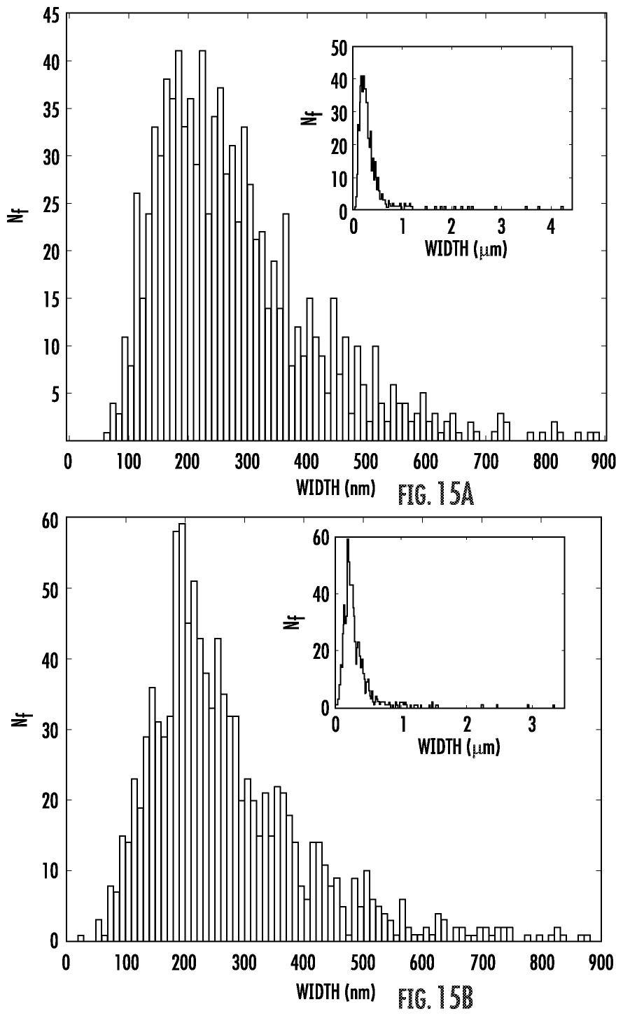

The nano-scale fibril morphology of CNFs, before and after ultrasonic dewatering, is assessed by contrast SEM imaging. It is noted that the drying step used for SEM image sample preparation may collapse of the fibrils into unwanted agglomeration, so the morphology that is measured may not be what is observed in the wet state. Despite this, SEM analysis is used here to confirm nano-size scale features of the CNFs. Contrast SEM images for the diluted original sample at 0.001 wt. % and at various magnification is shown in FIGS. 14A-14B. These images show the forked, branched nature of CNF samples. The messy nature of the CNF lends to the difficulty associated with their dimension characterisation and reporting a single width dimension is not a true representation of these morphology. The histogram in FIG. 15A shows that majority of original CNF samples width ranges between 20-500 nm. Images for redispersed ultrasonic dewatered samples (dewatered to 11 wt. %) diluted to 0.001 wt.% presented in FIGS. 14C-14D shows a similar trend in fibril width and is shown in the histogram in FIG. 15B. SEM images along with the width histograms for rest of the samples are also analysed (not shown). Thus, these analyses confirm the presence of nanostructure in these fibrils while also confirming that no significant morphological changes occur during the dewatering process.

### Benchmarking Study

A preliminary benchmarking study was completed to assess the redispersion performance of our ultrasonic dewatered samples with filter-pressed samples (alternate dewatering method) and freeze-dried samples. Filter-pressed CNF dewatered to 15 wt. % and freeze-dried CNFs, were obtained from the Process Development Centre at UMaine. Microscopy images of the redispersed samples are were taken. In general, the filter-pressed and freeze-dried samples did not redisperse as well as the ultrasonication method used in the current study. The high level of CNF agglomeration complicated image analysis (optical and SEM) of filter-pressed and freeze-dried samples and could not be completed with current approaches used in this study.

### Energy Consumption to Dewater

The existing dewatering and drying methods for CNFs are highly energy intensive, thereby making it desirable to develop energy-efficient and economically sustainable dewatering/drying methods. Ultrasonic dewatering system for CNFs is developed with these goals in mind and estimation of its energy consumption is conducted. Based on the power rating for a single VMT used in this study i.e. 2.4 J/s, the energy consumed by the ultrasonic dewatering platform is estimated for per kilogram of water removed. For this calculation, we assume that the system is operating at 1T configuration and 10 ml/hr flow rate of the CNF, which takes 30 mins to dewater 5 grams of a 3 wt. % CNF suspension. The dewatering time is extrapolated for removal of 1 kg of water from CNF suspension and the energy consumed by the system is estimated to be ˜1542.8 kJ/kg of water removed (summarized in the Table). A comparison of the 2T system with the 1T system is also presented in the Table.

Energy consumption data for CNM dewatering processes such as centrifugation, filtration, shear induced dewatering or pressing is not available in literature to the best of our knowledge. While energy consumption comparison with these methods would have been ideal, we evaluate our system based on thermal drying systems to offer a rough estimate. The enthalpy of evaporation of water at 25° C. is 2441.7 kJ/kg (Engineering Toolbox 2010), which is the minimum energy that must be supplied for any thermal drying system. The average energy consumption value for an industrial spray drier, the most widely used drying technique for CNMs, is ˜5469.3 kJ/kg of water removed (Baker and Mckenzie 2005) which is significantly higher than the estimated energy consumption for the ultrasonic dewatering system. It is also worthwhile mentioning that the transducers used in this study are inexpensive (<$1 each) and are easily available for bulk purchase. Thus, the low energy requirements of these transducers along with their low capital cost makes ultrasonic dewatering a promising energy efficient and economically viable alternative for dewatering of CNFs.

TABLE
Overview of operational and economical parameters
for the ultrasonic dewatering platform

| | | | | Final CNF | |
|---|---|---|---|---|---|
| | Initial | Dewatered | Time | concen- | |
| System | weight | water % | taken | tration | Energy consumed |
| 1T | 5 g of 3 wt. | ~56 wt. % | 30 | ~7 wt. % | ~1542.8 kJ/kg of |
| | % CNF | | mins | | water removed |
| 2T | 5 g of 3 wt. | 72 wt. % | 30 | ~11 wt. % | ~2400 kJ/kg of |
| | % CNF | | mins | | water removed |

A new dewatering technique that uses ultrasonic transducers to remove water from the CNF suspension is introduced in the present work. The custom build ultrasonic dewatering platform is shown to efficiently remove water from the system without triggering agglomeration of the fibrils. The flow rate and the spatial transducer configurations are varied to study their effect on the dewatering performance. Decreasing the flow rate of the CNF suspension resulted in an increase in the amount of water removal for the system. This is due to the increased residence time of the suspension over the transducer surface. However, the trade-off for increased dewatering is longer dewatering durations (due to lower flow rates) along with the higher inconsistency in the amount of water removed (higher error bars) due to the low-pressure induced phase separation within the syringe at lower flow rates. On the other hand, increasing the number of transducers increases the amount of water removed for all flow rate through an increased working contact area between the transducer and the suspension. The dewatering rate for our system is found to be directly dependent on the flow rate as well as the transducer number as a result of the non-linear dewatering behaviour of the transducer. Up to 72% of water removal is achieved, corresponding to a final CNF concentration of ˜11 wt. %.

The redispersion of the dewatered samples achieved via vortex mixing resulted in homogeneous suspensions with no additional agglomeration observed on visual inspection. Further analysis using phase contrast microscopy provided a fast and easy technique for microscale visualisation of these fibrils. Dimensional analysis of the fibrils revealed a similar histogram distribution for the redispersed samples when compared to the original sample. Finally, energy estimations revealed that the proof-of-concept system operates at reduced energy requirements when compared to thermal drying systems thus presenting a promising prospect for an energy-efficient and economically sustainable alternative for CNF dewatering.

The present inventive concepts are described herein with reference to the accompanying drawings and examples, in which embodiments are shown. Additional embodiments may take on many different forms and should not be construed as limited to the embodiments set forth herein. Rather, these embodiments are provided so that this disclosure will be thorough and complete, and will fully convey the scope of the inventive concepts to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting thereof. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of “over” and “under.” The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

It will be understood that, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present disclosure. The sequence of operations (or steps) is not limited to the order presented in the claims or figures unless specifically indicated otherwise.

The foregoing is illustrative of the present inventive concept and is not to be construed as limiting thereof. Although a few example embodiments have been described, those skilled in the art will readily appreciate that many modifications are possible in the exemplary embodiments without materially departing from the novel teachings of this inventive concept. Accordingly, all such modifications are intended to be included within the scope of this inventive concept as defined in the claims. Therefore, it is to be understood that the foregoing is illustrative of the present inventive concept and is not to be construed as limited to the specific embodiments disclosed, and that modifications to the disclosed embodiments, as well as other embodiments, are intended to be included within the scope of the appended claims.

### REFERENCES

Al Zaitone B (2019) Drying kinetics of cellulose nanofibers suspensions. In: 21st International Drying Symposium. pp 11-14
Amini E (Nima), Tajvidi M, Bousfield D W, et al (2019) Dewatering Behavior of a Wood-Cellulose Nanofibril Particulate System. Sci Rep 9:1-10. https://doi.org/10.1038/s41598-019-51177-x
Astorsdotter J (2017) Dewatering Cellulose Nanofibril Suspensions through Centrifugation
Baker C G J, Mckenzie K A (2005) Energy Consumption of Industrial Spray Dryers. Dry Technol 23:365-386. https://doi.org/10.1081/DRT-200047665
Beck S, Bouchard J, Berry R (2012) Dispersibility in Water of Dried Nanocrystalline Cellulose. Biomacromolecules 13:1486-1494
Beuguel Q, Tavares J R, Carreau P J, Heuzey M (2018) Ultrasonication of spray- and freeze-dried cellulose nanocrystals in water. J Colloid Interface Sci 516:23-33. https://doi.org/10.1016/j.jcis.2018.01.035
Boucher R M G (1959a) Ultrasonic boosts heatless drying.pdf. Chem Eng 66:151-154
Boucher R M G (1959b) Drying by airborne Ultrasonics. Ultrason news 3:8-9
Clayton S A, Scholes O N, Hoadley A F A, et al (2006) Dewatering of biomaterials by mechanical thermal expression. Dry Technol 24:819-834. https://doi.org/10.1080/07373930600733093
Čolić M, Tomić S, Bekić M (2020) Immunological aspects of nanocellulose. Immunol Lett 222:80-89. https://doi.org/10.1016/j.imlet.2020.04.004
Dimic-Misic K, Maloney T, Gane P (2018) Effect of fibril length, aspect ratio and surface charge on ultralow shear-induced structuring in micro and nanofibrillated cellulose aqueous suspensions. Cellulose 25:117-136. https://doi.org/10.1007/s10570-017-1584-3
Dimic-Misic K, Maloney T, Liu G, Gane P (2017) Micro nanofibrillated cellulose (MNFC) gel dewatering induced at ultralow-shear in presence of added colloidally-unstable particles. Cellulose 24:1463-1481. https://doi.org/10.1007/s10570-016-1181-x
Dimic-Misic K, Puisto A, Paltakari J, et al (2013) The influence of shear on the dewatering of high consistency nanofibrillated cellulose furnishes. Cellulose 20:1853-1864. https://doi.org/10.1007/s10570-013-9964-9
Engineering, Toolbox (2010) Water-Heat of Vaporization. https://www.engineeringtoolbox.com/water-properties-d_1573.html. Accessed 4 Jun. 2021
Foster E J, Moon R J, Heux L, et al (2018) Current characterization methods for cellulose nanomaterials. Chem Soc Rev 47:2609-2679. https://doi.org/10.1039/c6cs00895j
Gallego-Juárez J A, Riera E, de la Fuente Blanco S, et al (2007) Application of high-power ultrasound for dehydration of vegetables: Processes and devices. Dry Technol 25:1893-1901. https://doi.org/10.1080/07373930701677371
Gallego-Juárez J A, Rodriguez-Corral G, Moraleda J C G, Yang T S (1999) A new high-intensity ultrasonic technology for food dehydration. Dry Technol 17:597-608. https://doi.org/10.1080/07373939908917555
García-Pérez J V, Carcel J A, Mulet A, et al (2015) Ultrasonic drying for food preservation. In: Power Ultrasonics. Elsevier, pp 875-910
Geng L, Mittal N, Zhan C, et al (2018) Understanding the Mechanistic Behavior of Highly Charged Cellulose Nanofibers in Aqueous Systems. Macromolecules 51:1498-1506. https://doi.org/10.1021/acs.macromol.7b02642
Greguss P (1963) The mechanism and possible applications of drying by ultrasonic irradiation. Ultrasonics 1:83-86. https://doi.org/10.1016/0041-624X(63)90059-3
Han J, Zhou C, Wu Y, et al (2013) Self-assembling behavior of cellulose nanoparticles during freeze-drying: Effect of suspension concentration, particle size, crystal structure, and surface charge. Biomacromolecules 14:1529-1540. https://doi.org/10.1021/bm4001734
Hanif Z, Jeon H, Tran T H, et al (2018) Butanol-mediated oven-drying of nanocellulose with enhanced dehydration rate and aqueous re-dispersion. J Polym Res 25:191
Iwamoto S, Nakagaito A N, Yano H, Nogi M (2005) Optically transparent composites reinforced with plant fiber-based nanofibers. Appl Phys A 1112:1109-1112. https://doi.org/10.1007/s00339-005-3316-z
Miller T, Kramer C, Fisher A (2015) Bandwidth Study on Energy Use and Potential Energy Saving Opportunities in U.S. Pulp and Paper Manufacturing. US Dep Energy
Missoum K, Bras J, Belgacem M N (2012) Water Redispersible Dried Nanofibrillated Cellulose by Adding Sodium Chloride. Biomacromolecules 13:4118-4125
Moon R J, Martini A, Nairn J, et al (2011) Cellulose nanomaterials review: structure, properties and nanocomposites. Chem Soc Rev 40:3941. https://doi.org/10.1039/c0cs00108b
Musielak G, Mierzwa D, Kroehnke J (2016) Food drying enhancement by ultrasound—A review. Trends Food Sci Technol 56:126-141. https://doi.org/10.1016/j.tifs.2016.08.003
Nigmatullin R, Johns M A, Muñoz-García J C, et al (2020) Hydrophobization of Cellulose Nanocrystals for Aqueous Colloidal Suspensions and Gels. Biomacromolecules 21:1812-1823. https://doi.org/10.1021/acs.biomac.9b01721
Park C-W, Han S-Y, Namgung H-W, et al (2017) Effect of Spray-drying Condition and Surfactant Addition on Morphological Characteristics of Spray-dried Nanocellulose. J For Environ Sci 33:33-38. https://doi.org/10.7747/jfes.2017.33.1.33
Patel D K, Dutta S D, Lim K T (2019) Nanocellulose-based polymer hybrids and their emerging applications in biomedical engineering and water purification. RSC Adv 9:19143-19162. https://doi.org/10.1039/c9ra03261d
Peng C, Momen A M, Moghaddam S (2017a) An energy-efficient method for direct-contact ultrasonic cloth drying. Energy 138:133-138. https://doi.org/10.1016/j.energy.2017.07.025
Peng C, Ravi S, Patel V K, et al (2017b) Physics of direct-contact ultrasonic cloth drying process *. Energy 125:498-508. https://doi.org/10.1016/j.energy.2017.02.138
Peng Y, Gardner D J (2013) Influence of drying method on the material properties of nanocellulose I: thermostability and crystallinity. Cellulose 20:2379-2392
Peng Y, Gardner D J, Han Y (2012a) Drying cellulose nanofibrils: In search of a suitable method. Cellulose 19:91-102. https://doi.org/10.1007/s10570-011-9630-z
Peng Y, Gardner D J, Han Y, et al (2013) Influence of drying method on the surface energy of cellulose nanofibrils determined by inverse gas chromatography. J Colloid Interface Sci 405:85-95. https://doi.org/10.1016/j.jcis.2013.05.033
Peng Y, Gardner D J, Han Y (2012b) Drying Cellulose Nanofibrils: Morphology Characterization. In: 55th International Convention of Society of Wood Science and Technology. pp 1-9
Penttila P A, Ra P, Maunu S L, et al (2012) The effect of drying method on the properties and nanoscale structure of cellulose whiskers. 901-912. https://doi.org/10.1007/s10570-012-9695-3
Quiévy N, Jacquet N, Sclavons M, et al (2010) Influence of homogenization and drying on the thermal stability of microfibrillated cellulose. Polym Degrad Stab 95:306-314
Rantanen J, Maloney T C (2015) Consolidation and dewatering of a microfibrillated cellulose fiber composite paper in wet pressing. Eur Polym J 68:585-591. https://doi.org/10.1016/j.eurpolymj.2015.03.045
Rebouillat S, Pla F (2013) State of the Art Manufacturing and Engineering of Nanocellulose: A Review of Available Data and Industrial Applications. J Biomater Nanobiotechnol 04:165-188. https://doi.org/10.4236/jbnb.2013.42022
Sabarez H, Swiergon P, Knoerzer K (2019) Drying process and apparatus
Sehaqui H, Liu A, Zhou Q, Berglund L A (2010) Fast Preparation Procedure for Large, Flat Cellulose and Cellulose/Inorganic Nanopaper Structures. 2195-2198
Sethi J, Oksman K, Illikainen M, Sirvio J A (2018) Sonication-assisted surface modification method to expedite the water removal from cellulose nanofibers for use in nanopapers and paper making. Carbohydr Polym 197:92-99. https://doi.org/10.1016/j.carbpol.2018.05.072
Sim K, Lee J, Lee H, Youn H J (2015) Flocculation behavior of cellulose nanofibrils under different salt conditions and its impact on network strength and dewatering ability. Cellulose 22:3689-3700. https://doi.org/10.1007/s10570-015-0784-y
UMaine The Process development Center. https://umaine.edu/pdc/nanocellulose/.Accessed 7 Jul. 2021
Wetterling J, Jonsson S, Mattsson T, Theliander H (2017) The Influence of Ionic Strength on the Electroassisted Filtration of Microcrystalline Cellulose. Ind Eng Chem Res 56:12789-12798. https://doi.org/10.1021/acs.iecr.7b03575
Wetterling J, Sahlin K, Mattsson T, et al (2018) Electroosmotic dewatering of cellulose nanocrystals. Cellulose 25:2321-2329. https://doi.org/10.1007/s10570-018-1733-3
Zhai L, Kim H C, Kim J W, Kim J (2020) Simple centrifugal fractionation to reduce the size distribution of cellulose nanofibers. Sci Rep 1-8. https://doi.org/10.1038/s41598-020-68642-7
Zimmermann M V G, Borsoi C, Lavoratti A, et al (2016) Drying techniques applied to cellulose nanofibers. J Reinf Plast Compos 35:682-697. https://doi.org/10.1177/0731684415626286

1. A dewatering system comprising:
a platform having a first side configured to receive a material thereon and an opposing second side, the platform having a plurality of pores extending between the first and second side, wherein the material comprises a solid portion and a liquid portion, and
an ultrasound transducer in communication with the platform and configured to vibrate the material on the platform such that the liquid portion passes through the plurality of pores and the solid portion remains on the platform.

2. The dewatering device of claim 1, wherein the ultrasound transducer comprises a mesh transducer having a vibrating mesh surface, and platform is provided by the vibrating mesh surface of the mesh transducer.

3. The dewatering device of any preceding claim 1, wherein the ultrasound transducer has a frequency of about 20 kHz to about 2 MHz.

4. The dewatering device of claim 1, wherein the solid portion of the material is in a slurry or suspension with the liquid portion of the material.

5. The dewatering device of claim 1, wherein the ultrasound transducer comprises a piezoelectric ultrasound transducer having the plurality of pores in a central portion thereof.

6. The dewatering device of claim 5, wherein the platform and the plurality of pores are provided by a mesh on the piezoelectric ultrasound transducer.

7. The dewatering device of claim 1, wherein the plurality of pores has a graduated diameter that is larger on a first side of the platform and decreases as the pores extend to the second side of the platform.

8. The dewatering device of claim 1, wherein a diameter of the plurality of pores is less than 10 μm.

9. The dewatering device of claim 1 further comprising a vacuum supply configured to apply a negative pressure to the second side of the platform.

10. The dewatering device of claim 1, wherein the material comprises cellulose nanofiber.

11. The dewatering device of claim 1, further comprising a filter on the platform, the filter configured to further filter the liquid portion from the solid portion.

12. The dewatering device of claim 1, wherein the plurality of pores is sized and configured to allow the liquid portion to pass through the plurality of pores and to maintain the solid portion of the material on the platform.

13. The dewatering device of claim 1, further comprising a hydrophobic surface on the platform.

14. A dewatering system comprising:
a holder configured to hold a dewatering device, the dewatering device comprising:
a platform having a first side configured to receive a material thereon and an opposing second side, the platform having a plurality of pores extending between the first and second side, wherein the material comprises a solid portion and a liquid portion; and
an ultrasound transducer in communication with the platform and configured to vibrate the material on the platform such that the liquid portion passes through the plurality of pores and the solid portion remains on the platform.

15. The dewatering system of claim 14, further comprising a supplier configured to supply the material to the platform.

16. The dewatering system of claim 14, wherein the material supplier comprises a syringe.

17. The dewatering system of claim 14, wherein the holder is configured to hold the platform and the ultrasound transducer in a vertical configuration.

18. The dewatering system of claim 17, further comprising a movable blade configured to move in a direction along the platform to move the material from one end of the platform to another, opposite end of the platform.

19. The dewatering system of claim 14, wherein the holder comprises a conveyor configured to move the material along the platform and the transducer.

20. The dewatering system of claim 19, wherein the dewatering device comprises a plurality of dewatering devices positioned along the conveyor.

21. The dewatering system of claim 20, wherein the holder comprises a cylinder having a hollow middle portion and an outer surface, and the cylinder is configured to receive the material in the hollow middle portion, and the the plurality of dewatering devices are on the cylinder.

22. The dewatering system of claim 21, wherein the plurality of dewatering devices is positioned on the cylinder such that the second side of each of the plurality of dewatering devices are on the outer surface of the cylinder.

23. A dewatering method comprising:
providing a material on a platform, the platform having a first side configured to receive the material thereon and an opposing second side, the platform having a plurality of pores extending between the first and second side, and the material comprises a solid portion and a liquid portion; and
sonicating the material with an ultrasound transducer in communication with the platform and that is configured to vibrate the material on the platform such that the liquid portion passes through the plurality of pores and the solid portion remains on the platform.

24.-35. (canceled)
